(19) United States
(12) Patent Application Publication
(10) Pub. No.: US 2005/0166733 A1
(43) Pub. Date: Aug. 4, 2005

(54) Rotary web cutting system with resilient mounting assembly for shaped knife blades

(76) Inventor: Marc C. Piscitello, Plainfield, IL (US)

Correspondence Address: MCANDREWS HELD & MALLOY, LTD, 500 WEST MADISON STREET, SUITE 3400, CHICAGO, IL, 60661, US

(21) Appl. No.: 10/767,519

(22) Filed: Jan. 29, 2004

(51) Int. Cl. B26D 1/56

(52) U.S. Cl. 83/37; 83/469

(57) ABSTRACT

A knife holder mounted on the periphery of a knife roller in an apparatus for cutting lengths of webs such as paper is disclosed. The knife holder in the system disclosed is formed of an elastomeric material. The knife blades have shaped configurations in order to cut contours, angles, curves, or geometric shapes into the web. The knife blades are held in place principally by friction in slots cut into the knife holder and seat themselves in the elastomer during set-up and changing. Additionally, flexibility in milling shapes and contours, reduced and even wear of knife blades, and prevention of deformation or displacement of cutting blades is achieved.

### FIELD OF THE INVENTION

The present invention relates to an improved apparatus for cutting a web of paper or other material such as foil, thin plastic, or webs of combined layers of these or similar materials. More specifically, the present invention relates to a resilient assembly for mounting shaped (for example, curved, arcuate, angled, or geometric) knife blades onto the periphery of a knife roller of a rotary cutting system. The resilient knife mounting assembly is affixed onto the knife roller and is capable of cutting a traveling web into a number of pieces, with flexibility to mill the web into various straight, angled and/or curved shapes and/or contours. In its preferred embodiment, the system is capable of cutting a web of paper.

### BACKGROUND OF THE INVENTION

Papercutting machines are widely used in such industries as the printing industry, and rotary paper cutting machines are widely used for cutting strips or webs of paper to a desired size. Generally, these paper cutting machines consist of two cooperating rollers, one which has knives mounted upon it, and the other acts as an anvil against which the knives bear as the paper is cut. The cutting edges of the knives and the surface of the anvil normally rotate at the same speed, and the paper is cut as the cutting edges of the knives move into and out of engagement with the anvil surfaces. It is desired that the paper cut as cleanly, accurately, and rapidly as possible, and to this a number of prior art patents are directed. U.S. Pat. Nos. 2,660,242; 2,682,306; 3,709,077; 3,857,314; 3,893,359; and 4,640,165 describe representative rotary-type paper-cutting machines. These and other similar machines are most suited to cutting paper only along a straight-edge, however. As a result, these machines are not well suited to cutting contoured edges or otherwise milling the edges of the cut paper into different shapes.

In the conventional rotary papercutting machine, a straight, longitudinal blade or blades cuts the paper. In typical machines, such as that described in U.S. Pat. No. 3,857,314, the knife is mounted in a rigid base member, which is in turn mounted on a rotatable roller. The knife is attached to the base member by a plurality of bolts which hold the knife in a precise position for proper engagement with the anvil surface. To install a fresh knife, it is necessary to first mount the knife onto the base member and then lightly tighten the bolts to provide a coarse adjustment of the position of the knife on the base member. The anvil and knife rollers are then rotated until the knife pushes against the anvil, causing the knife to seat itself in the proper cutting position. Each of the bolts holding the knife to the base member is then tightened to a specified torque to secure the knife in its final cutting position. This process is referred to as the “rolling-in” or torque-fitting procedure.

Because these conventional papercutting machines use rigid base members, they are unable to effectively employ curved or contoured cutting blades. The directional forces exerted on the blades during operation would deform or destroy a blade that attempts to curve around the knife roller, or at the very least would result in uneven wear on the blades, thus eliminating the blades ability to cut cleanly. Additionally, conventional papercutting machines attempting to employ curved or shaped blades would require precise, lengthy, time-consuming torque-fitting to hold the cutting knives in place on the roller. As a result, these conventional papercutting machines cannot effectively cut contours, curves, or shapes into a web of paper.

In another apparatus, as described in U.S. Pat. No. 4,640,165, which is included by reference, the knife unit includes cutting knives mounted within a knife holder formed of an elastomeric material. During the setup of the knife roller and later during the cutting operation, the knife holder yields within its elastic limits to take up displacement of the cutting knifes caused by radial and circumferential forces imposed upon them by the anvil surface. However, this apparatus can only accommodate straight, longitudinal cutting blades that cut a single clean edge. This apparatus is unable to cut a curved, contoured, or shaped edge.

The present web cutting system with a resilient mounting assembly for shaped knife blades is directed to overcoming these and other difficulties inherent in prior art conventional web cutting systems. In the present apparatus, a knife unit includes shaped cutting knives mounted within a knife holder formed of an elastomeric material. These shaped knives can be formed of a variety of angles, arcs, curves, and/or geometric shapes and can be configured to conform to the curvature of the knife roller. During the setup of the knife roller and later during the cutting operation, the knife holder yields within its elastic limit to take up displacement of the shaped cutting knifes caused by radial and circumferential forces imposed upon them by the anvil surface. Additionally, because the elastic knife holder yields beneath the entire length and width of the shaped blade, the blade itself is not exposed to excessive stresses, which can bend or deform it. The yield of the elastic knife holder also ensures that the shaped blade will wear evenly and uniformly. Moreover, the present web cutting system reduces the need for precise, lengthy, time-consuming torque-fitting of bolts to hold the cutting knives in place on the roller.

Embodiments of the present web cutting system thus provide one or more of the following advantageous operational features:
(1) a rotary knife system which can mill shapes or cut contoured edges into a paper web;
(2) a rotary knife system which accommodates shaped (including curved, angled, arcuate, and/or geometric) knives within a resilient base;
(3) a rotary knife system where the cutting knives have a circumferential directional component;
(4) a rotary knife system which prevents excessive deformation of shaped cutting blades;
(5) a rotary knife system which prevents uneven wear of shaped cutting blades;
(6) a rotary knife system which employs shaped (including curved, angled, or arcuate) knives, and which does not require precise, lengthy, time-consuming torque-fitting of bolts to hold the cutting knives in place on the roller.

### SUMMARY OF THE INVENTION

The above and other advantageous operational features are accomplished by providing a knife holder with shaped blades, which can be mounted on the periphery of a knife roller. These shaped blades can be formed of a variety of angles, arcs, curves, and/or geometric shapes and are capable of conforming to the curvature of the knife roller. The body of the holder can be made of an elastomeric material, and the cutting knives are carried within slots formed in the resilient elastomer. The elastomer allows the knife holder to yield within its elastic limits during set-up and also during the cutting operation to take up displacement of the cutting knives caused by the imposition of force by the anvil surface.

Because the elastic knife holder yields beneath the entire length and width of the shaped blade, the blade itself is not exposed to excessive stresses, which can bend or deform it. The yield of the elastic knife holder also ensures that the curved or shaped blade will wear evenly and uniformly.

In a preferred embodiment of the present web cutting system, the knife holder is molded from a urethane polymer having a Shore D hardness of about 70-80. The cross sectional thickness of the cutting knife carried within the slot in the knife holder is broad enough so that the radially inward or bottom edge of the cutting knife does not itself cut into the knife holder. The radially inward or bottom surface of the cutting knife is preferably convex so that force is distributed evenly at the interface with the elastomeric material.

In this embodiment, the knife holder further holds at least two opposing arcuate or curved knife blades. These knife blades are offset circumferentially from the longitudinal center axis of the knife holder. These knife blades curve and conform to the circumference of the knife roller and preferably oppose each other in mirror relation to provide for consistent contoured edges in a finished cut of paper. Such mirror relation is not mandatory, however, to achieve the advantages of the present assembly.

While it is not intended that the present web cutting system should be limited to any particular theory, it is believed that the radial force imposed on the cutting knife by the anvil is transmitted through the knife material to the bottom surface of the knife. It is believed that the bottom surface of the knife then transmits that force to the elastomeric material forming the knife holder. As a result the elastomeric material then yields within its elastic limits to absorb the force placed upon it by the knife. It is also believed that the elastomeric material absorbs the force along the entire circumferential component of the knife as the knife roller is rotated. It is further believed that this absorption of force contributes to even wear of curved or shaped blades and prevents deformation of the blades.

In another embodiment of the present web cutting system, the resilient knife holder, in addition to containing at least two opposing curved blades in mirror relation, also contains at least one straight blade contained between the curved blades. This straight blade is capable of cutting the chip of web material left between two or more curved blades during the cutting process.

In another embodiment of the present web cutting system the knife holder is also formed of an elastomeric material. The shaped blades in this embodiment are configured so that the action of the apparatus produces an angled or curved geometric shape in the traveling web of material. Some examples of such geometric shapes can include, but are not limited to, hearts, stars, circles, or ovals.

In yet another embodiment of the present web cutting system, the knife holder contains at least two shaped knife blades that are offset circumferentially from the longitudinal center axis of the knife holder, while another knife blade extends linearly along the longitudinal center axis of the knife holder. This linearly extending blade has a plurality of spaced, outwardly radially presented tines. These tines are capable of piercing and removing chips of the traveling web of material.

### BRIEF DESCRIPTION OF THE DRAWINGS

FIG. 1 is a side view, partly in section, of a portion of a rotary papercutting apparatus showing the relationship of cooperating knife, anvil, knife units, and traveling web of material in accordance with at least one embodiment of the apparatus.

FIG. 2 is an enlarged view of a knife roller, showing the relationship of the cutting knife units in accordance with at least one embodiment of the apparatus.

FIG. 3 is a perspective view of a section of a knife roller, showing a knife unit mounted on the periphery of the knife roller, and the shape and arrangement of the cutting knives in accordance with at least one embodiment of the apparatus.

FIG. 4 is an enlarged view of the surface of a knife blade holder, showing the shape and relationship of the cutting knives in accordance with at least one embodiment of the apparatus.

FIG. 5 is an end view of a knife unit, showing the relationship of the knife holder, the circumferential component of the knife blades, and the radial curvature and conformity of the knife blades in accordance with at least one embodiment of the apparatus.

### DETAILED DESCRIPTION OF PREFERRED EMBODIMENT(S)

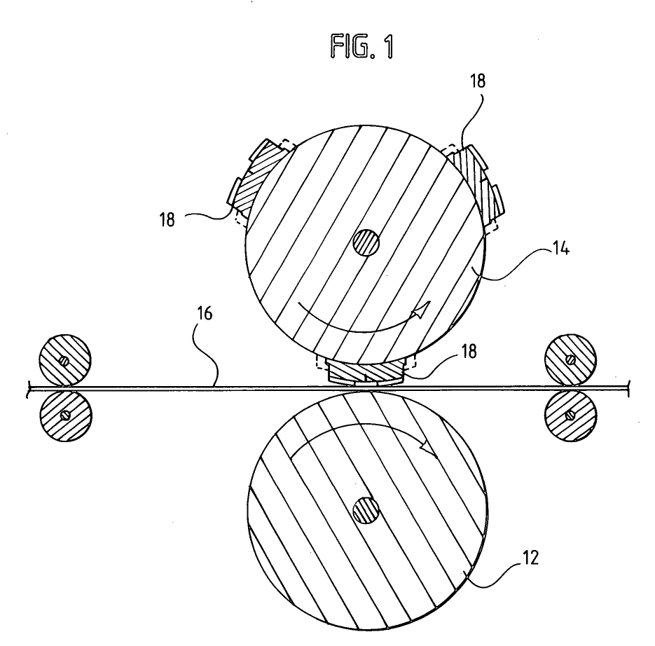

Turning first to FIG. 1 of the drawings, a knife roller 14 is shown adjacent to and above an anvil roller 12 with a web 16 between the rollers. These rollers rotate in relationship to one another about parallel axes, as shown by the directional arrows. The knife roller 14 and anvil roller 12 are arranged so that web 16 is passed between them. The web 16 can be severed at the desired places by action of the knife units 18, against the anvil roller 12.

Rollers 12 and 14 can be positioned in reverse configuration in some conditions and can be offset from each other in separate normal vertical planes. An offset allows for better product control as the web is cut and delivered from the cylinders. The preferred degree of offset is in the range of about 5 degrees to 15 degrees to the side of the anvil roller.

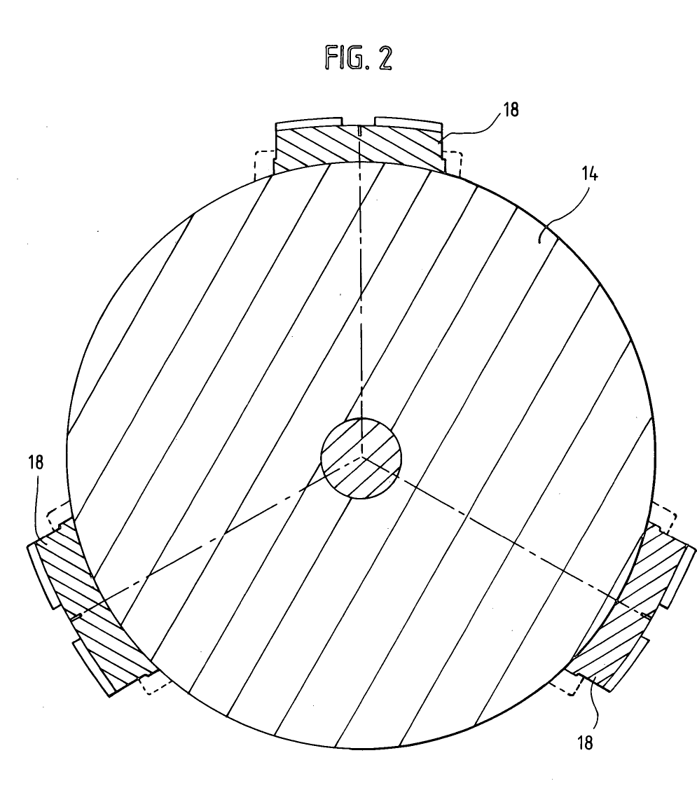

A plurality of knife blade units 18 is also shown in FIG. 1. As shown in FIG. 1 and more specifically in FIG. 2, all of the knife units 18 are substantially identical. These knife blade units 18 are made up of at least one knife blade holder 20 and one or more knife blades 19. The positioning of the knife blade units 18 can be adjusted to control the shape and length of a section of cut web 16. The speed of the traveling web can also affect the shape and length of the section of cut web 16. In the embodiment shown in FIG. 1, and as more particularly shown in FIG. 2, three knife units 18 are configured at 120 degree angles from each other. However, it may be desirable to employ only one or a plurality of knife units. For example, one embodiment of the present web cutting system can be configured for up to eight knife units. It is preferred that the knife blade units 18 be positioned angularly such that the knife roller 14 rotates in a balanced state. In a balanced state, the knife roller 14 is more effective in exerting uniform radially force, thus promoting uniform knife blade wear.

Also as shown in FIG. 1, and as more particularly shown in FIG. 3, the knife units 18 are mounted lengthwise of the knife roller 14. The knife units 18 can be of any suitable length so as to accommodate various web widths passing the knife roller 14. The knife holder 20 shown in FIG. 3 can be of the order of twenty inches long, and a similar assembly can be disposed in end-to-end relationship to it on the surface of the knife roller 14 so as to employ the full length of a knife roller.

The following description of a knife unit concerns the formation of a knife unit 18 that accommodates a resilient knife holder 20, and two curved, opposing blades 19 in general mirror relation to each other. It will be recognized in view of this description that other forms of knife units can be designed on the same concepts, so as, for example, to provide for a different number of blades or blades configured to cut a variety of arcs, curves, angles, geometric shapes, or serrations into a web.

As shown in FIG. 2, and more particularly in FIG. 3, a pair of opposing knife blades 19 in general mirror relation to each other extend from knife unit 18 so as to intersect the paper web 16 while it lies against anvil roller 12, and there cut the web into desired lengths, shapes, or contours. The severed sheets are received by any suitable conventional sheet removal and handling mechanism (not shown) for delivery to further processing stations.

The cutting action will also produce a chip of web due to the spacing between the shaped knife blades 19. This chip of web can be allowed to fall away from the severed sheets. Alternatively, in another embodiment of the apparatus, an additional knife blade extends linearly along the longitudinal center axis of said knife holder. This linearly extending blade can be a uniform blade to cut the web chip into a smaller piece, or can have a plurality of spaced, outwardly radially presented tines. These tines are capable of piercing and removing chips of the traveling web of material.

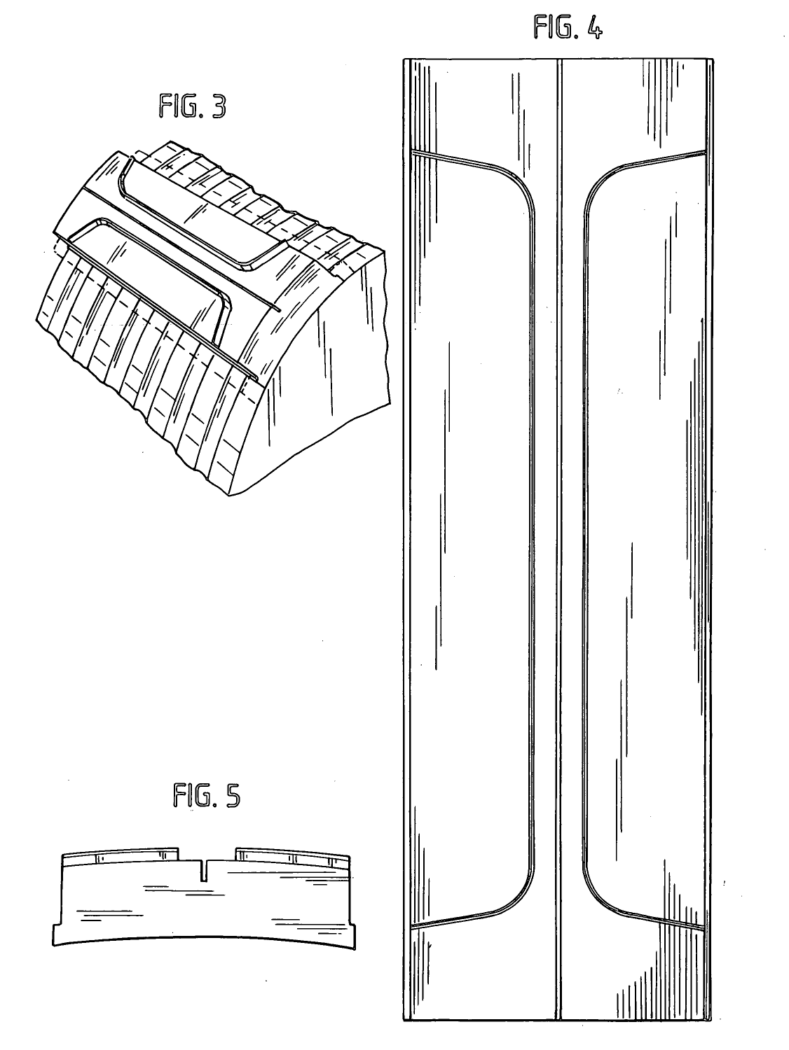

The knife blades 19, as shown in FIGS. 3 and 4, have a circumferential directional component. The knife blades extend in not only the longitudinal direction, but also in the circumferential direction. In the illustrated embodiment, the knife blades are generally straight along the longitudinal direction for a distance from their center, until they curve circumferentially away from the center axes at their ends.

The knife blades 19, as shown in FIG. 3 and more particularly in FIG. 5, preferably conform to the contours of the knife roller 14. The knife blades 19 are preferably convex in the radial direction so that radial forces are absorbed evenly over the length of the knife blade as the knife roller 14 rotates. In the preferred embodiment, as the knife roller rotates, the radial forces are absorbed evenly by a resilient knife holder 20, as discussed below.

The knife blades 19 are preferably made of suitable knife steel in flat strips beveled and sharpened along one edge. The opposite edges of the blades are preferably convex in cross-section. Such a configuration avoids as much as possible cutting into an elastomeric knife holder in which the blades are mounted when pressure is exerted on the sharpened edges of the blades. The knife blades can either be single-beveled or double beveled. In addition to a straight cutting edge, the knife blades 19 can also have a serrated, saw-toothed, or otherwise uneven cutting edge.

The knife blades 19 can also be of a shorter length than the knife slots formed in the knife holder. Thus, users of the present apparatus can mount knives 19 of varying lengths in the knife holder 20 according to the requirements of particular cutting or shaping uses without being compelled to employ a knife which can be too long. For example, a 10-inch long knife can be mounted within a 20-inch long knife holder when the web to be cut is less than 10 inches in width. One shortcoming of this arrangement, however, is the potential for nonuniformity in the knife slot(s) caused by blade impact along only a portion of the slot(s).

In one embodiment, the knife blades 19 are formed as in FIG. 5, where the knife blades have a cross-sectional thickness of about 0.083 to 0.085 inch. In other embodiments, knife blades have a cross-sectional thickness of about 0.042 to 0.043 inch. Other knife blade cross-sectional thicknesses can also be accommodated.

The knives 19 are contained in a knife holder 20, as shown in FIGS. 3 and 5, which is preferably made of a resilient elastomer. This resilient elastomer preferably has a Shore D hardness of about 70-80. Some suitable elastomers can include, but are not limited to, any suitable synthetic thermosetting high polymers having properties similar to those of vulcanized natural rubber. For example, one of the many types of suitable elastomers for use in the present apparatus includes urethane polymers.

It is also preferred that the knife holder elastomer of the present apparatus should be capable of yielding within its elastic limits to accommodate forces exerted upon the knife blades 19 by the anvil roller 12 during the operation of the apparatus. Preferably, the knife holder elastomer has sufficient elasticity to prevent uneven wear or deformation of the knife blades, or loosening of the knife blades 19 from the holder 20.

The knife blades 19 are preferably seated in the knife holder 20 in slots shaped to receive contoured, angled, or shaped knives. The width of each of the slots is only slightly less than the cross sectional thickness of the blades, thus permitting the blades to be held in the slots principally by frictional engagement. The knife blade slots are formed with a preferable width of approximately 0.040 to 0.041 inch, which will properly receive the knife blades. Preferably, the knife blades have a cross-sectional thickness of about 0.042 to 0.043 inch, and the slots, when formed with a desirable width of approximately 0.040 to 0.041 inch, will properly receive the blades. It should be noted, however, that the present apparatus contemplates the use of any suitable knife blade and slot thickness for a variety of cutting purposes.

The knives 19 can be further retained in the knife holder 20 by a plurality of retaining pins as described in U.S. Pat. No. 4,640,165.

Assembly of the knife blade unit 18 on the knife roller 14 is shown in FIG. 3. The knife roller can be provided with a plurality of dovetail slots extending substantially around the circumference of the knife roller as described in U.S. Pat. No. 4,640,165. Knife blade units 18 incorporating elastomeric holders 20 as described above can also be adapted for use in older prior art papercutting apparatuses wherein the knife rollers have relatively smooth circumferential surfaces, rather than channeled surfaces. U.S. Pat. No. 4,640,165 describes some methods of retrofitting.

Additionally, the knife blade unit 18 can be configured to be movable circumferentially on the knife roller 14. Thus, a user of the apparatus can employ, for example, three knife blade units for one job, and four knife blade units for another job, both with the same knife roller. The knife blade unit 18 and knife roller 14 can be configured to either slide or re-attach the knife blade unit on the roller. For example, the clamping members described in U.S. Pat. No. 4,640,165 can be used to attach or move the knife rollers.

Preferably the knives 19, as shown in FIG. 3 and FIG. 5, cut a web by wiping it with their cutting edges against the surface of anvil roller 12, and the speed of the rollers 14 and 12 are synchronized to achieve cutting in this manner. The radius of the anvil roller 12 can be slightly less than the radius of the knife roller 14 measured to the tips of the knife blade units 18. This slight difference in the radii of the anvil roller 12 and knife roller 14 has been found to improve the cleanliness and accuracy of the cut, and has been found to prolong knife life.

While not being bound by any particular theory, it is believed that the slight difference in radii causes the wiping action of the cutting process and achieves a frictional force on the web 16 traveling between the cutting edge of the knife blades 19 and the surface of the anvil roller 12. These forces are in addition to the crushing of the paper fibers, which results from the striking of the cutting edges of the knives against the surface of the anvil roller 12.

While particular steps, elements, embodiments and applications of the present invention have been shown and described, it will be understood, of course, that the invention is not limited thereto since modifications can be made by persons skilled in the art, particularly in light of the foregoing teachings. It is therefore contemplated by the appended claims to cover such modifications and incorporate those steps or elements that come within the scope of the invention.

1. A rotary-type knife blade apparatus comprising:
(a) a knife roller;
(b) a cooperating anvil roller having an anvil on its periphery against which a traveling web of material is cut, said knife roller and said anvil roller being rotatable about parallel longitudinal axes in timed relationship to the travel of the traveling material therebetween;
(c) at least one knife carrying unit mounted on the periphery of said knife roller, said knife carrying unit comprising:
(1) a knife holder;
(2) at least one shaped slot formed in the radially outwardly presented surface of said knife holder, said shaped slot having a circumferentially extending component; and
(3) at least one shaped cutting knife capable of being carried within said shaped slot of said knife holder and having at least one radially outwardly presented cutting edge for engagement with said anvil to cut the traveling web material.

2. The apparatus of claim 1, wherein said knife holder is formed of a resilient elastomeric material having sufficient resiliency to accommodate radial force imposed upon said knife blade.

3. The apparatus of claim 2, wherein said shaped knife conforms radially and circumferentially to said knife roller.

4. The apparatus of claim 2, wherein said knife carrying unit is movable around the circumference of said knife roller.

5. The apparatus of claim 2, wherein said knife holder is formed of a resilient elastomeric material having a Shore D hardness of about 70-80.

6. The apparatus of claim 2, wherein said knife holder comprises a urethane polymer.

7. The apparatus of claim 1, wherein said knife holder additionally has a plurality of slots formed in the radially outwardly presented surface of said knife holder, at least one of said slots being said shaped slot, said shaped slot being offset circumferentially from the longitudinal center axis of the knife holder, and another one of said slots extending linearly along the longitudinal center axis of said knife holder, each of said slots capable of carrying a knife blade.

8. The apparatus of claim 7 wherein said linearly extending slot has a blade comprising a plurality of spaced, outwardly radially presented times, said tines capable of piercing and removing web chips.

9. The apparatus of claim 1, wherein said linearly extending slot has a perforating blade.

10. The apparatus of claim 1, wherein said cutting edge is uneven.

11. The apparatus of claim 1, wherein said knife blade is made of steel.

12. The apparatus of claim 1, wherein at least one shaped cutting knife is configured to cut a contoured edge into the traveling web material.

13. The method of claim 1, wherein at least one shaped cutting knife is configured to cut patterns into the traveling web material.

14. The apparatus of claim 1 wherein, said traveling web material is formed of a material selected from the group consisting of paper, foil, and plastic.

15. The apparatus of claim 1, wherein said traveling web material is a combined layer of at least two materials.

16. The apparatus of claim 1, wherein the diameter of said knife roller assembly is less than the diameter of said anvil roller assembly to create a wiping action of said cutting edge against said anvil.

17. In a rotary-type papercutting apparatus having a knife roller, a cooperating anvil roller against which the paper is cut, and a knife holder formed of a resilient elastomeric material, the improvement which compromises:
(a) at least one knife carrying unit mounted on the periphery of said knife roller, said knife carrying unit comprising:
(1) a knife holder formed of a resilient elastomeric material with sufficient resiliency to accommodate at least one directional force;
(2) at least one shaped slot formed in the radially outwardly presented surface of said knife holder, said shaped slot having a circumferentially extending component
(3) at least one shaped cutting knife capable of being carried within said shaped slot of said knife holder and having at least one radially outwardly presented cutting edge for engagement with said anvil to cut the paper, said shaped or curved knife capable of conforming to the contour of the knife roller; and
(b) a retention mechanism for retaining said knife holder on the periphery of said knife roller comprising at least one retaining member and a fastener passing through said retaining member and into receptacles within said knife roller.

18. A method for cutting a traveling web of material, comprising the steps of:
(a) passing a web of material between a rotatable knife roller and a cooperating anvil roller, said knife roller comprising at least one knife carrying unit mounted on the periphery of said knife roller;
(b) rotating said knife roller and said anvil roller upon parallel axes so that a knife carrying unit approaches said traveling web of material;
(c) engaging said traveling web of material with at least one shaped cutting knife having a circumferentially extending component, said shaped knife mounted on said knife carrying unit in an elastomeric knife holder;
(d) cutting the traveling web of material with at least one radially outwardly presented cutting edge of said shaped cutting knife; and
(e) continuing to rotate said knife roller and said anvil roller so that at least one shaped cutting knife engages the paper along the entire circumferential component of said shaped cutting knife, said elastomeric knife holder yielding within its elastic limits during the cutting operation to take up displacement of said cutting knife by said anvil roller and to allow said cutting knife to settle into its cutting position within said roller.

19. The method of claim 18, wherein at least one shaped cutting knife cuts a contoured edge into the traveling web of material.

20. The method of claim 18, wherein at least one shaped cutting knife cuts patterns or shapes into the traveling web of material.
